(19) United States
(12) Patent Application Publication
(10) Pub. No.: US 2025/0254659 A1
(43) Pub. Date: Aug. 7, 2025

(54) METHOD AND APPARATUS OF DATA TRANSMISSION

(71) Applicant: LENOVO (BEIJING) LIMITED, Beijing (CN)

(72) Inventors: Mingzeng Dai, Shanghai (CN); Ran Yue, Beijing (CN); Lianhai Wu, Beijing (CN); Jing Han, Beijing (CN)

(21) Appl. No.: 18/856,747

(22) PCT Filed: Apr. 15, 2022
(86) PCT No.: PCT/CN2022/087133

§ 371 Date: Oct. 14, 2024

(51) Int. Cl. H04W 68/02; H04W 74/00

(52) U.S. Cl. CPC H04W 68/02; H04W 74/006

(57) ABSTRACT

Embodiments of the present application relate to a method and apparatus of data transmission. An exemplary apparatus may include: a transceiver; and a processor coupled to the transceiver, wherein the processor is configured to: transmit, via the transceiver, a first RAN paging for MT-SDT; receive, via the transceiver, downlink non-SDT data for a UE after transmitting the first RAN paging; and transmit, via the transceiver, information of non-SDT data arrival for transmitting the downlink non-SDT data.

### TECHNICAL FIELD

Embodiments of the present application generally relate to wireless communication technology, especially to a method and apparatus of data transmission.

### BACKGROUND

In 3GPP (3rd generation partnership project) 5G system, small data transmission (SDT) is introduced for several application scenarios. For example, according to an agreement of 3GPP TSG RAN Meeting #86, a small data transmission can be used for smartphone applications including traffic from instant messaging services or used for non-smartphone applications including traffic from wearables. A small data transmission may also be named as a small data packet or the like. Generally, any device that has intermittent small data transmissions in a non-connected state, e.g., a radio resource control (RRC) inactive state or a RRC idle state will benefit from enabling small data transmission in the non-connected state.

New radio (NR) release (Rel)-17 specified mobile oriented (MO)-SDT to allow small packet transmission for uplink (UL)-oriented packets. For downlink (DL), mobile terminated (MT)-SDT (i.e., DL-triggered small data) allows similar benefits, e.g., reducing signaling overhead and user equipment (UE) power consumption by not transitioning to RRC_CONNECTED and reducing latency by allowing fast transmission of (small and infrequent) packets, e.g., for positioning. In Rel-18, it was agreed to specify the following support for paging-triggered SDT, e.g., MT-SDT according to RP-213583:
MT-SDT triggering mechanism for UEs in RRC_INACTIVE, supporting random access (RA)-SDT and configured grant (CG)-SDT as the UL response; and
MT-SDT procedure for initial DL data reception and subsequent UL/DL data transmissions in RRC_INACTIVE.

However, several issues on MT-SDT have not been discussed yet. For example, if there is DL non-SDT arrives at radio access network (RAN) during a MT-SDT procedure, transmission of the non-SDT data needs a large latency and high signalling overhead.

Given the above, the industry desires improved technology associated with small data transmission, especially associated with MT-SDT.

### SUMMARY OF THE APPLICATION

One objective of the embodiments of the present application is to provide a technical solution of data transmission, e.g., technical solutions of supporting non-SDT data arrival during a MT-SDT procedure with small latency and low signaling overhead etc.

Some embodiments of the present application provide a radio access network (RAN) node, e.g., an anchor gNB or last serving gNB, which includes: a transceiver; and a processor coupled to the transceiver, wherein the processor is configured to: transmit, via the transceiver, a first RAN paging for MT-SDT; receive, via the transceiver, downlink non-SDT data for a UE after transmitting the first RAN paging; and transmit, via the transceiver, information of non-SDT data arrival for transmitting the downlink non-SDT data.

In some embodiments of the present application, the information of non-SDT data arrival is transmitted in response to arrival of the downlink non-SDT data within running time of a timer. In an example, the information of non-SDT data arrival is a second RAN paging for non-SDT transmitted to the UE to overwrite the first RAN paging. In another example, the information of non-SDT data arrival is a second RAN paging for non-SDT transmitted to a receiving BS of the UE to overwrite the first RAN paging. The second RAN paging may have a priority higher than the first RAN paging. In yet another example, the information of non-SDT data arrival is an indication of overwriting the first RAN paging in a second RAN paging for non-SDT transmitted to a receiving BS of the UE.

In some embodiments of the present application, the information of non-SDT data arrival is transmitted in the case of receiving a request message in response to the first RAN paging within running time of a timer. The processor is configured to buffer the received downlink non-SDT data before receiving the request message. The processor is configured to: initialize a second RAN paging for non-SDT to transmit the downlink non-SDT data in the case of not receiving the request message until expiry of the timer. In an example, the request message is a RRC resume request from the UE, and the information of non-SDT data arrival is a RRC resume message to the UE to enter a RRC connected state. In another example, the request message may be a retrieval UE context request from a receiving BS of the UE, and the information of non-SDT data arrival is an indication of non-SDT data arrival in a retrieval UE context response message to the receiving BS.

In some embodiments of the present application, the timer is started in response to any data of the SDT data being received or the first RAN paging being transmitted.

In some embodiments of the present application, the timer is configured according to at least one of paging discontinuous reception (DRX) cycle of a receiving BS of the UE, identifier (ID) of the UE or default paging DRX cycle of the UE.

In some embodiments of the present application, a RAN node include a central unit (CU) control plane (CP) and a CU user plane (UP) coupled to the CU CP, wherein, the CU UP transmits information indicating whether downlink data arrival is SDT data arrival or non-SDT data arrival to the CU CP in response to the downlink data arrival, and the CU CP transmits the first RAN paging in response to the information indicating SDT data arrival. In an example, the information indicating whether downlink data arrival is SDT data arrival or non-SDT data arrival may be an indication of SDT data arrival, and the CU UP transmits to the CU CP the indication of SDT data arrival in response to a data volume of received data being less than or equal to a threshold. In another example, the information indicating whether downlink data arrival is SDT data arrival or non-SDT data arrival is an ID of data radio bearer (DRB), or ID of protocol data unit (PDU) session or ID of quality of service (QoS) flow. In another example, the information indicating whether downlink data arrival is SDT data arrival or non-SDT data arrival is a data volume of each received SDT DRB or each PDU session or each QoS flow or data volume of all received SDT DRBs or all received PDU sessions or all QoS flows.

In some embodiments of the present application, the MT-SDT is for signaling radio bearer (SRB), and the processor is configured to: receive an indication indicating whether a signaling for the UE released into the RRC non-connected state is subject to SDT; and transmit the first RAN paging in the case that the signaling is indicated as being subject to SDT.

Some embodiments of the present application provide another RAN node, e.g., a receiving gNB or new serving gNB, which includes: a transceiver; and a processor coupled to the transceiver, wherein the processor is configured to: receive, via the transceiver, a first RAN paging for MT-SDT from a last serving BS of a UE; receive, via the transceiver, information of non-SDT data arrival from the last serving BS; and transmit, via the transceiver, a message overwriting the first RAN paging to the UE in response to the information of non-SDT data arrival in the case that the first RAN paging has not been transmitted yet.

In some embodiments of the present application, the information of non-SDT data arrival is a second RAN paging for non-SDT to overwrite the first RAN paging, and the message is the second RAN paging. The second RAN paging may have a priority higher than the first RAN paging.

In some embodiments of the present application, the information of non-SDT data arrival is an indication of overwriting the first RAN paging in a second RAN paging for non-SDT to overwrite the first RAN paging, and the message is the second RAN paging.

In some embodiments of the present application, the processor is configured to transmit a retrieval UE context request, the information of non-SDT data arrival is an indication of non-SDT data arrival in a retrieval UE context response message in response to the retrieval UE context request, and the message is a RRC resume message.

In some embodiments of the present application, in the case that the first RAN paging has been transmitted to the UE before receiving the information of non-SDT data arrival, the processor is configured to ignore the information of non-SDT data arrival or transmit a feedback to the last serving BS indicating the first RAN paging has been transmitted to the UE.

Some other embodiments of the present application provide a remote apparatus, e.g., a UE, which includes: a transceiver; and a processor coupled to the transceiver, wherein the processor is configured to: receive, via the transceiver, a first RAN paging for MT-SDT; receive, via the transceiver, a second RAN paging overwriting the first RAN paging; and initialize a RRC resume procedure in response to the second RAN paging in the case that a MT-SDT procedure in response to the first RAN paging has not be initialized.

In some embodiments of the present application, the processor is configured to initialize the MT-SDT procedure by a RRC layer in response to the first RAN paging before receiving the second RAN paging. The RRC layer may indicate a medium access control (MAC) layer that the MT-SDT procedure is initialized.

In some embodiments of the present application, a MAC entity does not use data volume threshold sdt-DataVolumeTrehsold in the case that the MT-SDT procedure is initialized in a layer upper than a MAC layer.

Embodiments of the present application provide a method and apparatus of data transmission, which can solve issues on MT-SDT, e.g., issues on how to support non-SDT data arrival during a MT-SDT procedure with low latency and low signaling overhead, and how to distinguish whether a signaling is subject to SDT or non-SDT in the case of MT-SDT for signaling radio bearer (SRB) etc. Accordingly, the present application can facilitate and improve the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application.

FIG. 2 illustrates a schematic diagram of an internal structure of a RAN node according to some embodiments of the present application according to some embodiments of the present application.

FIG. 3 is a schematic diagram illustrating an internal structure of a BS according to some other embodiments of the present application.

FIG. 4 is a flow chart illustrating an exemplary procedure of a method of data transmission according to some embodiments of the present application.

FIG. 5 is a flow chart illustrating an exemplary procedure of a method of data transmission in Scenario 1 according to some embodiments of the present application.

FIG. 6 is a flow chart illustrating an exemplary procedure of a method for small data transmission in Scenario 1 according to some other embodiments of the present application.

FIG. 7 is a flow chart illustrating an exemplary procedure of a method for small data transmission in Scenario 2 according to some embodiments of the present application.

FIG. 8 is a flow chart illustrating an exemplary procedure of a method for small data transmission in Scenario 2 according to some other embodiments of the present application.

FIG. 9 illustrates a block diagram of an apparatus for small data transmission according to some embodiments of the present application.

FIG. 10 illustrates a block diagram of an apparatus for small data transmission according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two terminal device 102 (e.g., a UE 102a and UE 102b) for illustrative purpose. Although a specific number of BSs and terminal devices are illustrated in FIG. 1 for simplicity, it is contemplated that the wireless communication system 100 may include more or less BSs and terminal devices in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), an access and mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node. Each BS may serve a number of UE(s) within a serving area, for example, a cell or a cell sector via a wireless communication link. Neighbor BSs may communicate with each other as necessary, e.g., during a handover procedure for a UE.

The terminal device (or remote apparatus) 102, e.g., the UE 102a and UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the terminal device may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the terminal device may include wearable devices, such as smart watches, fitness bands, optical head-mounted displays, or the like. Moreover, the terminal device may be referred to as a subscriber unit, a mobile, a mobile station, a user, a terminal, a mobile terminal, a wireless terminal, a fixed terminal, a subscriber station, a user terminal, or a device, or described using other terminology used in the art. Herein (through the specification), although “UE” is used exemplarily as a classical terminal device for illustrating the terminal device, it should be understood as any type terminal device.

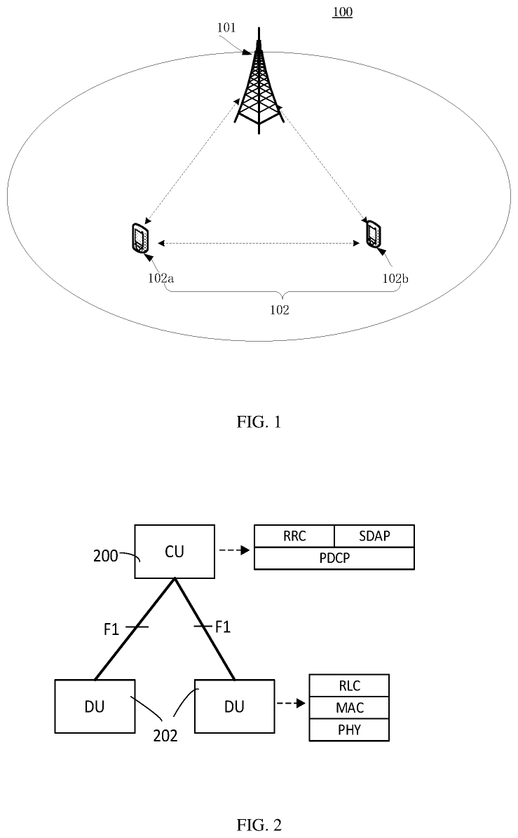

FIG. 2 is a schematic diagram illustrating an internal structure of a RAN node, e.g., a BS according to some embodiments of the present application.

Referring to FIG. 2, in a CU-DU split based RAN architecture, the internal structure of a RAN node (e.g., BS 101) may be split into a CU 200 and at least one DU 202 (e.g., two DUs shown in FIG. 2). Although a specific number of DUs 202 are depicted in FIG. 2, it is contemplated that any number of DUs 202 may be included in the BS.

The CU 200 and DU 202 are connected with each other by an interface called F1 as specified in 3GPP standard documents. The RRC layer functionality, service data adaptation protocol (SDAP) functionality, and the packet data convergence protocol (PDCP) layer functionality are located in the CU 200. The radio link control (RLC) layer functionality, medium access control (MAC) layer functionality, and the physical (PHY) layer functionality are located in the DU 202.

According to some embodiments of the present application, the CU may be separated into a central unit control plane (CU CP or CU-CP) unit and at least one central unit user plane (CU UP or CU-UP) unit.

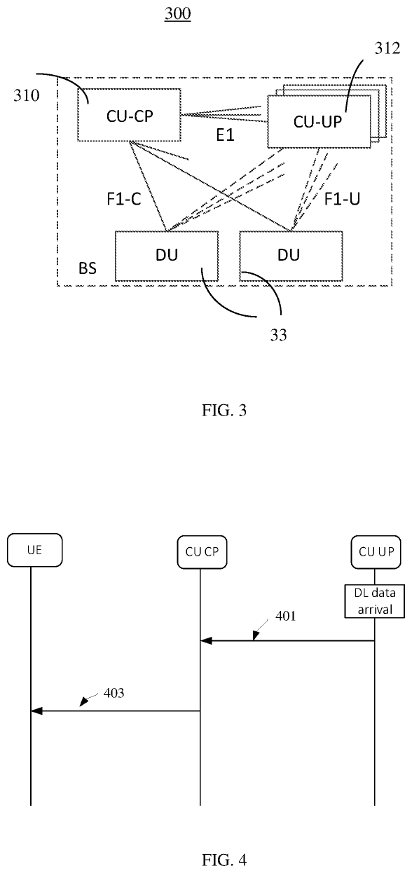

FIG. 3 is a schematic diagram illustrating an internal structure of a BS 300 according to some other embodiments of the present application.

Referring to FIG. 3, the CU of the BS 300 may be separated into a CU CP unit 310 and at least one CU UP 312. The CU CP unit 310 and each CU UP unit 312 may be connected with each other by an interface called E1 as specified in 3GPP standard documents. The CU CP unit 310 and the DU 33 of the BS 300 are connected by an interface called F1-C as specified in 3GPP documents. Each CU UP unit 312 and the DU 33 are connected by an interface called F1-U as specified in 3GPP standard documents.

In LTE, in the case that a remote apparatus 102, e.g., a UE in a non-connected state wants to transmit data, it may trigger an early data transmission (EDT) procedure. The EDT procedure may include an EDT procedure for control plane (CP) cellular internet of things (CIoT) evolved packet system (EPS) optimizations and an EDT procedure for user plane (UP) CIoT EPS optimizations. In the EDT procedure for CP CIoT EPS optimizations, the data may be transmitted through a RRC early data request message. In the EDT procedure for UP CIoT EPS optimization, the data may be transmitted through an RRC connection resume request message.

The EDT procedure evolves into a SDT procedure in NR. In Rel-18, it was agreed to specify the support for MT-SDT, i.e., downlink SDT. However, there are a mass of issues on MT-SDT to be solved.

For example, one issue concerns how to support non-SDT data arrival during a MT-SDT procedure. In legacy technology, when downlink SDT data arrives at a RAN node, e.g., a gNB, the RAN node will initialize a MT-SDT paging. The UE will perform a SDT procedure in response to receiving the MT-SDT paging. The RAN node will send the UE back into RRC_INACTIVE due to the downlink non-SDT data arrival. Then, the RAN node will send a RAN paging to the UE for the downlink non-SDT data arrival. The UE will perform a RRC state transition to RRC_CONNECTED for transmission of the downlink non-SDT data. The RAN node will transmit the downlink non-SDT data to the UE after the UE enters RRC_CONNECTED. Thus, transmission of the non-SDT data arriving during the MT-SDT procedure is disadvantageous in large latency and high signaling overhead in legacy technology.

Given the above, embodiments of the present application provide technical solutions of data transmission, especially for solving issues on data transmission associated with MT-SDT, e.g., how to support non-SDT data arrival during a MT-SDT procedure, how to distinguish whether a signaling is subject to SDT or not in the case of MT-SDT for SRB, how the CU CP and CU UP of a gNB cooperate to handle MT-SDT, and how to initialize a MT-SDT procedure in UE in response to a RAN paging for MT-SDT, etc. Herein, only downlink data, e.g., MT-SDT data or downlink non-SDT data is considered.

Specifically, when a gNB receives downlink SDT data from core network (CN), that is, there is downlink SDT data arrival in the gNB, the gNB will trigger a MT-SDT procedure (or referring to as downlink SDT procedure, a SDT procedure for MT-SDT, or just referring to as a SDT procedure or the like) in response to the downlink SDT data arrival. The MT-SDT data may be for user plane data or control plane signaling. For example, for a UE released to a RRC non-connected state, e.g., in RRC_INACTIVE, the gNB may receive downlink SDT control plane signaling, e.g., for positioning (also referred to as MT-SDT for SRB) from the CN, and the gNB will trigger a MT-SDT RAN paging procedure (also referring to a RAN paging procedure for MT-SDT, or just a RAN paging procedure for SDT or the like). However, the gNB cannot distinguish a signaling, e.g., non-access stratum (NAS) PDU from the CN is subject to SDT or not. According to some embodiments of the present application, an indication indicating whether a signaling is subject to SDT or not will be indicated to the gNB by the CN. In the case that a signaling is indicated as being subject to SDT, the gNB will trigger a MT-SDT procedure and transmit a RAN paging for MT-SDT (also referring to a MT-SDT RAN paging, or just a RAN paging for SDT or the like).

In an example, the CN, e.g., the access and mobility management function (AMF) of the CN will indicate to the gNB whether a signaling, e.g., a NAS PDU is subject to SDT or not by an explicit indication, e.g., by the information element (IE) name. When the gNB receives the NAS PDU, the gNB will identify that the NAS PDU is subject to SDT based on the IE name. In some embodiments of the present application, when releasing the UE to a RRC non-connected state, the gNB may indicate to the CN, e.g., the AMF that the UE is released to the RRC non-connected state, so that the AMF will provide such an indication as expected.

In another example, the indication indicating whether a signaling is subject to SDT or not is a specific message, e.g., a new specific message defined for transmitting the downlink SDT signaling from the CN to gNB. When receiving such a message, the gNB will know it is for MT-SDT SRB and will trigger a MT-SDT paging procedure. In some embodiments of the present application, the gNB receives a LTE positioning protocol (LPP) message, the gNB will identify that the LPP message is subject to SDT based on the message name. Accordingly, the gNB will transmit a RAN paging for MT-SDT.

In the case of CU CP and CU UP split in a gNB, a MT-SDT paging procedure will be triggered by the CU CP. However, downlink data for a UE in a RRC non-connected state will firstly arrive at the CU UP. According to some embodiments of the present application, the CU UP will inform the arrival of the downlink data to the CU CP so that the CU CP triggers a RAN paging procedure for informing the UE to return to a RRC connected state. Considering the scenario of MT-SDT, the CU CP needs to know whether the downlink data is downlink SDT data or downlink non-SDT data, so that the CU CP can trigger a RAN paging for MT-SDT or a RAN paging for non-SDT. The RAN paging for non-SDT may be a normal RAN paging procedure as legacy, and is also referred to as a normal RAN paging procedure.

FIG. 4 is a flow chart illustrating an exemplary procedure of a method of data transmission according to some embodiments of the present application, wherein communications between CU CP and CU UP of a gNB is shown.

As shown in FIG. 4, for a downlink data arrival, the CU UP will transmit information indicating whether downlink data arrival is SDT data arrival or non-SDT data arrival to the CU CP in step 401, e.g., including such information in DL DATA NOTIFICATION message. When the information indicates a SDT data arrival, the CU CP will trigger a MT-SDT paging procedure. Then, the CU CP will transmit a RAN paging for MT-SDT in step 403. When the information indicates a non-SDT data arrival or does not indicate a SDT data arrival or there is even no such information, the CU CP will trigger a RAN paging procedure for non-SDT, e.g., a normal RAN paging procedure. Then, the CU CP will transmit a RAN paging for non-SDT in step 403.

In some embodiments of the present application, the information indicating whether downlink data arrival is SDT data arrival or non-SDT data arrival is an indication of SDT data arrival or indication of non-SDT arrival. For example, when receiving downlink data of SDT RB or SDT PDU session or SDT QoS flow from the CN, e.g., use plane function (UPF) of the CN, the CU UP may decide whether to transmit an indication of SDT data arrival or indication of non-SDT arrival according to the data volume of the data arriving at the CU UP. In the case that the data volume is less than or equal to a configured threshold, the CU UP will include the indication of SDT data arrival, e.g., in DL DATA NOTIFICATION message. Otherwise, the CU UP will not include the indication of SDT data arrival or include an indication of non-SDT data arrival in DL DATA NOTIFICATION message. In some embodiments of the present application, the configured threshold is configured by the CU CP, e.g., the CU CP sends the configured threshold to the CU UP.

In some other embodiments of the present application, the CU CP may implicitly indicate whether a data arrival is a SDT data arrival or a non-SDT arrival. The CU CP can determine whether the data arrival is SDT arrival or non-SDT arrival based on the information indicated by the CU CP.

For example, the information indicating whether downlink data arrival is SDT data arrival or non-SDT data arrival is DRB ID(s), or PDU session ID(s) or QoS flow ID(s) of the arrived (or received) data. The CU UP includes such DRB ID(s) or PDU session ID(s) or QoS flow ID(s) of the arrived data in a message, e.g., DL DATA NOTIFICATION message. According to the included DRB ID(s) or PDU session ID(s) or QoS flow ID(s), the CU CP will know whether the arrived data is subject to MT-SDT or non-SDT. Then, the CU CP will decide to perform a MT-SDT paging procedure in the case that the arrived data is subject to MT-SDT or a non-SDT paging procedure in the case that the arrived data is subject to non-SDT.

In another example, the information indicating whether downlink data arrival is SDT data arrival or non-SDT data arrival is a data volume of each received SDT DRB, each PDU session or each QoS flow or the data volume of all received SDT DRBs or all PDU Sessions or all QoS flows. The CU CP will know whether the arrived data is subject to MT-SDT or non-SDT according to the indicated data volume. Then, the CU CP will decide to perform a MT-SDT paging procedure in the case that the arrived data is subject to MT-SDT or a non-SDT paging procedure in the case that the arrived data is subject to non-SDT.

In yet another example, the information indicating whether downlink data arrival is SDT data arrival or non-SDT data arrival may a combination of the above exemplary information. For example, the CU UP may indicate to the CU CP both the DRB ID(s), or PDU session ID(s) or QoS flow ID(s) of the arrived data and the data volume of the arrived data.

After receiving the RAN paging for MT-SDT, the UE will initialize a MT-SDT procedure. In Rel-17, a data volume threshold sdt-DataVolumeThreshold, which is configured by RRC is used by the UE to determine whether to perform a uplink SDT procedure, i.e., a MO-SDT procedure. In the case that the data volume of the pending uplink data across all RBs configured for SDT is less than or equal to sdt-DataVolumeThreshold, the UE will continue to perform the SDT procedure. Otherwise, the UE will consider that conditions for initializing a SDT procedure are not fulfilled, and then perform a non-SDT procedure.

However, in the case of MT-SDT, when the UE initializes the MT-SDT procedure in response to the MT-SDT paging, there is no pending uplink data across all RBs configured for SDT. Considering that, according to some embodiments of the present application, the RRC layer in UE, i.e., the UE RRC layer will initialize the MT-SDT procedure when receiving a RAN paging for MT-SDT. The UE RRC layer will indicate to the layers lower than the RRC layer, e.g., MAC layer, that the upper layer initializes a MT-SDT procedure. In the case that the MT-SDT procedure is initialized by the upper layer, the MAC entity will not use the data volume threshold sdt-DataVolumeTrehsold. In other words, the data volume threshold sdt-DataVolumeTrehsold is only used for MO-SDT procedures according to some embodiments of the present application. The data volume threshold will not be used for determining whether to perform a MT-SDT procedure.

Regarding downlink non-SDT data, in some cases, when it arrives, the gNB has not received downlink SDT data. The gNB will trigger a RAN paging procedure as legacy. In some cases, when it arrives, the gNB has received downlink SDT data, but has not triggered a RAN paging procedure for MT-SDT. Similarly, the gNB will trigger a RAN paging procedure for the non-SDT as legacy.

However, in some cases, non-SDT data may arrive at the gNB closely following the SDT data, e.g., arriving during a MT-SDT procedure. As stated above, in legacy technology, the transmission of non-SDT data in such scenarios needs high signaling overhead and has large latency. Embodiments of the present application also solve this issue. For example, according to some embodiments of the present application, a method, e.g., performed in a RAN node may include: transmitting a RAN paging for MT-SDT, receiving downlink non-SDT data for a UE after transmitting the RAN paging for MT-SDT, and transmitting information of non-SDT data arrival for transmitting the downlink non-SDT data.

In some scenarios, the UE in a RRC non-connected state may not select a new cell, and there is only one gNB serving the UE, e.g., an anchor gNB (hereafter, Scenario 1). In some other scenarios, the UE in a RRC non-connected state may perform a cell selection or cell reselection to a new cell, and there are communications between the UE and the receiving gNB in the new cell, and communications between the receiving gNB and the anchor gNB (hereafter Scenario 2). The receiving gNB may also be referred to as a new serving gNB or serving gNB, and the anchor gNB may also be referred to as a last serving gNB or old serving gNB. Given that, more details on some embodiments of the present application are illustrated in view of the two exemplary scenarios as follows.

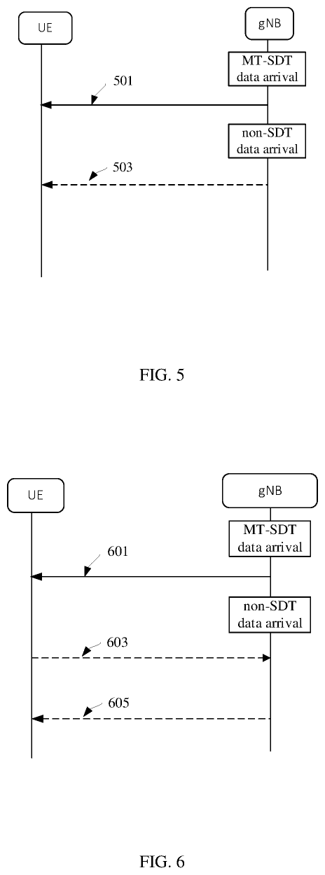

FIG. 5 is a flow chart illustrating an exemplary procedure of a method of data transmission in Scenario 1 according to some embodiments of the present application. Although the method is illustrated in a system level by a RAN node, e.g., a gNB and a remote apparatus, e.g., a UE, persons skilled in the art should understand that the method implemented in the gNB and UE can be separately implemented and/or incorporated by other apparatus with the like functions.

As shown in FIG. 5, according to some embodiments of the present application, in response to downlink SDT data arrival, the gNB may transmit a RAN paging for MT-SDT to a UE to initialize a MT-SDT procedure in step 501. The UE is in a non-connected state, e.g., in a RRC inactive state.

After transmitting the RAN paging for MT-SDT, there may be downlink non-SDT data arrival in the gNB, that is, the gNB receives downlink non-SDT data after transmitting the RAN paging for MT-SDT. At least to reduce signaling overhead and reduce latency, in the case that the downlink non-SDT data is received during the MT-SDT procedure within certain time, the gNB may try to overwrite or cancel the transmitted RAN paging for MT-SDT. For example, the gNB may transmit information of non-SDT data arrival to the UE for transmitting the downlink non-SDT data in step 503.

The information of non-SDT data arrival is various according to various embodiments to the present application, which can be an explicit or implicit indication.

In some embodiments of the present application, the information of non-SDT arrival may be a RAN paging for non-SDT to overwrite or replace the RAN paging for MT-SDT. For example, the RAN paging for non-SDT can overwrite the RAN paging for MT-SDT according to a predefined rule. When the UE receives a RAN paging for non-SDT and a SDT procedure has not been initialized yet, the UE will ignore the received RAN paging for MT-SDT and initialize a non-SDT procedure in response to the RAN paging for non-SDT according to the predefined rule. In another example, the RAN paging for non-SDT can overwrite the RAN paging for SDT by configuring the RAN paging for non-SDT with a priority higher than the RAN paging for SDT. When the UE receives the RAN paging for non-SDT with a higher paging priority for the same UE and the SDT procedure has not been initialized, the UE will initialize a non-SDT procedure in response to the RAN paging for non-SDT, rather than a SDT procedure in response to the RAN paging for SDT.

In some other embodiments of the present application, the information of non-SDT arrival may be an indication of overwriting the RAN paging for SDT, which can be included in a RAN paging for non-SDT or other message(s). When the UE receives the RAN paging for non-SDT including the indication of overwriting the RAN paging for SDT and a SDT procedure in response to the RAN paging for SDT has not been initialized yet, the UE will ignore the previously received RAN paging for MT-SDT and initialize a non-SDT procedure in response to the RAN paging for non-SDT.

The information of non-SDT data arrival is transmitted in the case of the arrival of the downlink non-SDT data within the running time of a timer (hereafter also referred to as the first timer). The timer can be configured in various manners. For example, the timer is started in response to any data of the SDT data being received or is started in response to the RAN paging for MT-SDT being transmitted. In any manner, the certain time for determining whether to overwrite the RAN paging for MT-SDT in response to the non-SDT data arrival can be determined. The gNB can configure the timer according to ID of the UE or default paging DRX cycle of the UE, or both of them. For the downlink non-SDT data received after the timer expires, the gNB will initialize a RAN paging for non-SDT as legacy to transmit the downlink non-SDT data.

The UE may receive both the RAN paging for MT-SDT transmitted from the gNB in step 501 and the RAN paging for non-SDT transmitted from the gNB in step 505. In the case that the UE has not initialized the MT-SDT procedure in response to the RAN paging for MT-SDT, the RAN paging for MT-SDT will be overwritten by the RAN paging for non-SDT in the UE, e.g., according to predefined rules or priority of the RAN paging for non-SDT or an indication of overwriting the RAN paging or SDT etc. The UE will not initialize the MT-SDT procedure in response to the RAN paging for MT-SDT. Instead, the UE will initialize a RRC resume procedure in response to the RAN paging for non-SDT. For example, in the case that the UE receives both the RAN paging for MT-SDT RAN and the RAN paging for non-SDT simultaneously, e.g., in the same paging occasion, the UE will prioritize the RAN paging for non-SDT, that is, the UE will initialize a RRC resume procedure for receiving the non-SDT data in response to the RAN paging for non-SDT. In the case that the UE receives the RAN paging for non-SDT after initializing a SDT procedure in response to the RAN paging for SDT, the UE will ignore the RAN paging for non-SDT.

In some other embodiments of the present application, when downlink non-SDT data arrives after sending a RAN paging for MT-SDT, the gNB may buffer the non-SDT data and wait for a request message in response to the RAN paging for MT-SDT, e.g., a RRC resume request message from the UE. The gNB may transmit the information of non-SDT data arrival in the case of receiving a request message in response to the RAN paging, e.g., a RRC resume message to enter the UE into a RRC connected state.

For example, FIG. 6 is a flow chart illustrating an exemplary procedure of a method of data transmission in Scenario 1 according to some other embodiments of the present application. Although the method is illustrated in a system level by a RAN node, e.g., a gNB and a remote apparatus, e.g., a UE, persons skilled in the art should understand that the method implemented in the gNB and UE can be separately implemented and/or incorporated by other apparatus with the like functions.

As shown in FIG. 6, in response to downlink SDT data arrival, the gNB may transmit a RAN paging for MT-SDT to a UE in a non-connected state to initialize a MT-SDT procedure in step 601.

After transmitting the RAN paging for MT-SDT, there may be downlink non-SDT data arrival in the gNB, that is, the gNB receives downlink non-SDT data after transmitting the RAN paging for MT-SDT. The gNB may buffer the received downlink non-SDT data, and wait for a request message in response to the RAN paging for MT-SDT within certain time.

Similarly, the gNB may count the certain time by setting a timer (hereafter also referred to as the second timer). For example, the gNB can configure the second timer according to paging DRX cycle of the receiving gNB, ID of the UE or default paging DRX cycle of the UE, or any combination of them. The gNB may start the second timer in response to any data of the SDT data being received or in response to the RAN paging for MT-SDT being transmitted. Although the first timer and the second timer can be configured in identical or similar manners, they should not be deemed as the timer.

In step 603, the gNB may receive a RRC resume request message from the UE. In the case that the RRC resume request message is received within the running time of the second timer, the gNB will transmit a RRC resume message in response to the RRC resume request message to the UE in step 605, so that the UE can enter a RRC connected state to receive the downlink non-SDT data. In the case that the RRC resume request message is not received after the second timer expires, the gNB will transmit a RAN paging for non-SDT as legacy. Accordingly, the signaling overhead and latency for transmitting the non-SDT data arriving during a MT-SDT procedure can be reduced.

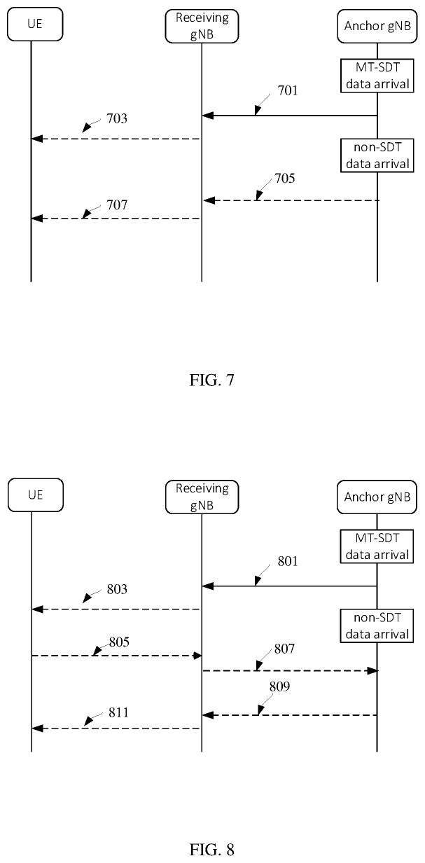

FIG. 7 is a flow chart illustrating an exemplary procedure of a method of data transmission in Scenario 2 according to some embodiments of the present application. Although the method is illustrated in a system level by two RAN nodes, e.g., an anchor gNB, a receiving gNB and a remote apparatus, e.g., a UE, persons skilled in the art should understand that the method implemented in the anchor gNB, the receiving gNB and the UE can be separately implemented and/or incorporated by other apparatus with the like functions.

As shown in FIG. 7, according to some embodiments of the present application, in response to downlink SDT data arrival for a UE, the anchor gNB may transmit a RAN paging for MT-SDT to the receiving gNB of the UE in step 701. The receiving gNB is expected to transmit the RAN paging for MT-SDT to the UE to initialize a MT-SDT procedure in step 703.

After transmitting the RAN paging for SDT, there may be downlink non-SDT data arrival in the anchor gNB, that is, the anchor gNB receives downlink non-SDT data after transmitting the RAN paging for SDT. In some embodiments of the present application the anchor gNB may try to overwrite or cancel the transmitted RAN paging for SDT in the case that the non-SDT arrives in certain time, which may be counted by a timer, e.g., the first timer. For example, the anchor gNB may transmit to the receiving gNB the information of non-SDT arrival to overwrite or replace the RAN paging for SDT in step 705.

The information of non-SDT data arrival is transmitted in the case of the arrival of the downlink non-SDT data within the running time of the timer, e.g., the first timer. For the downlink non-SDT data received after the first timer expires, the anchor gNB will initialize a RAN paging for non-SDT as legacy for transmitting the downlink non-SDT data.

Similarly, the anchor gNB can indicate to overwrite the RAN paging for MT-SDT by the information of non-SDT arrival in various manners. For example, in some embodiments of the present application, the information of non-SDT arrival is a RAN paging for non-SDT, which can overwrite the RAN paging for SDT according to a predefined rule or by configuring the RAN paging for non-SDT with a priority higher than the RAN paging for SDT. When the receiving gNB receives the RAN paging for non-SDT while the RAN paging for MT-SDT has not been transmitted by the receiving gNB to the UE, the receiving gNB will cancel the RAN paging for MT-SDT and replaced it with the RAN paging for non-SDT. That is, the receiving gNB will not transmit the RAN paging for MT-SDT to the UE in step 703, while will transmit the RAN paging for non-SDT to the UE in step 707.

In some other embodiments of the present application, the information of non-SDT arrival may be an indication of overwriting the RAN paging for MT-SDT, which can be included in a RAN paging for non-SDT or other message(s). When the receiving gNB receives a RAN paging message including the indication of overwriting the RAN paging for MT-SDT while the RAN paging for MT-SDT has not been transmitted by the receiving gNB to the UE, the receiving gNB will cancel the RAN paging for MT-SDT and replaced it with the RAN paging for non-SDT.

In the case that the receiving gNB has already sent the RAN paging for MT-SDT to the UE when receiving the information of non-SDT arrival, e.g., a RAN paging for non-SDT, the receiving gNB may ignore the information of non-SDT arrival or the receiving gNB will transmit feedback to the anchor gNB that the RAN paging for MT-SDT has already been sent to the UE. In some embodiments of the present application, another timer (hereafter, also referred to as a third timer) similar to the first timer may also be configured in the receiving gNB, which may be started in response to receiving the RAN paging for MT-SDT or after transmitting the RAN paging for MT-SDT. In the case that the receiving gNB receives the RAN paging for non-SDT within the running time of the third timer, the receiving gNB will transmit the RAN paging for non-SDT to the UE. Otherwise, the receiving gNB will ignore the RAN paging for non-SDT or transmit feedback to the anchor gNB that the RAN paging for MT-SDT has already been sent to the UE.

The UE may receive only the RAN paging for MT-SDT, or only the RAN paging for non-SDT, or both of them. When only receiving the RAN paging for MT-SDT, the UE will initialize a SDT procedure in response to the RAN paging for MT-SDT. When only receiving the RAN paging for non-SDT, the UE will initialize a non-SDT procedure in response to the RAN paging for non-SDT. In the case that the UE receives both the two RAN paging message while has not initialized the MT-SDT procedure in response to the RAN paging for MT-SDT, the RAN paging for MT-SDT will be overwritten by the RAN paging for non-SDT in the UE. The UE will not initialize the MT-SDT procedure in response to the RAN paging for MT-SDT. Instead, the UE will initialize a RRC resume procedure in response to the RAN paging for non-SDT. For example, in the case that the UE receives both the RAN paging for MT-SDT RAN and the RAN paging for non-SDT simultaneously, e.g., in the same paging occasion, the UE will prioritize the RAN paging for non-SDT, that is, the UE will initialize a RRC resume procedure for receiving the non-SDT data in response to the RAN paging for non-SDT. In the case that the UE receives the RAN paging for non-SDT after initializing a SDT procedure in response to the RAN paging for SDT, the UE will ignore the RAN paging for non-SDT.

In some other embodiments of the present application, when downlink non-SDT data arrives after sending a RAN paging for MT-SDT, the anchor gNB may buffer the non-SDT data and wait for a request message in response to the RAN paging for MT-SDT, e.g., a retrieve UE context request message from the receiving gNB. The anchor gNB may transmit the information of non-SDT data arrival in the case of receiving the request message, e.g., a retrieve UE context response message to the receiving gNB, so that the receiving gNB can transmit a RRC resume message to enter the UE into a RRC connected state for receiving the non-SDT data.

FIG. 8 is a flow chart illustrating an exemplary procedure of a method of data transmission in Scenario 2 according to some other embodiments of the present application. Although the method is illustrated in a system level by two RAN nodes, e.g., an anchor gNB, a receiving gNB and a remote apparatus, e.g., a UE, persons skilled in the art should understand that the method implemented in the anchor gNB, the receiving gNB and UE can be separately implemented and/or incorporated by other apparatus with the like functions.

As shown in FIG. 8, according to some embodiments of the present application, in response to downlink SDT data arrival for a UE, the anchor gNB may transmit a RAN paging for MT-SDT to the receiving gNB of the UE in step 801. The receiving gNB will transmit the RAN paging for MT-SDT to the UE to initialize a MT-SDT procedure in step 803.

After transmitting the RAN paging for SDT, there may be downlink non-SDT data arrival in the anchor gNB, that is, the anchor gNB receives downlink non-SDT data after transmitting the RAN paging for MT-SDT. The anchor gNB may buffer the received downlink non-SDT data and wait for a request message in response to the RAN paging for MT-SDT within certain time, e.g., a retrieve UE context request message from the receiving gNB. Similarly, the gNB may count the certain time by setting a timer, e.g., the second timer as stated above.

In step 805, the UE is expected to transmit to the receiving gNB a RRC resume request in response to the RAN paging for MT-SDT. In response to the received RRC resume request for SDT, the receiving gNB will transmit a retrieval UE context request message to the anchor gNB in step 807, e.g., with an SDT indication. In the case that the retrieval UE context request message is received within the running time of the second timer, the anchor gNB will decide that anchor relocation is needed. The anchor gNB will transmit a retrieval UE context response message to the receiving gNB in response to the retrieval UE context request message in step 809, which include the indication of non-SDT data arrival. The indication of non-SDT data arrival indicates that downlink data forwarding for non-SDT RB is requested or needed. Based on the retrieval UE context response message with the indication of non-SDT data arrival, the receiving gNB will decide to resume the non-SDT RB and move the UE into a RRC connected state. Then, the receiving gNB will send a RRC resume message in step 811 to enter the UE into a RRC connected state to receive the downlink non-SDT data. Accordingly, the signaling overhead and latency for transmitting the non-SDT data can be reduced. In the case that the retrieval UE context request message is received after the second timer expires, the anchor gNB will transmit a RAN paging for non-SDT as legacy.

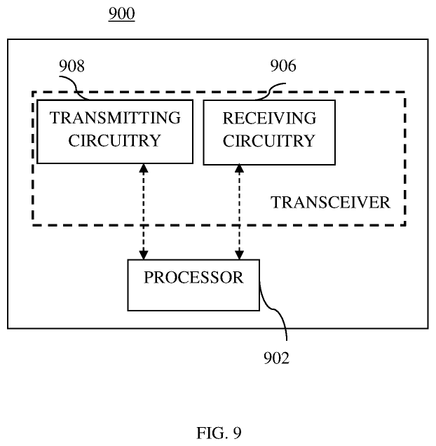

Besides methods, embodiments of the present application also propose an apparatus of data transmission. FIG. 9 is a block diagram of an apparatus of data transmission according to some embodiments of the present application.

Referring to FIG. 9, the apparatus 900, e.g., a UE or a RAN node may include at least one processor 902 and at least one transceiver 904. The transceiver 904 may include at least one separate receiving circuitry 906 and transmitting circuitry 908, or at least one integrated receiving circuitry 906 and transmitting circuitry 908. The at least one processor 902 may be a CPU, a DSP, a microprocessor etc.

According to some embodiments of the present application, when the apparatus 900 is a RAN node, e.g., a gNB or last serving gNB of a UE, the processor is configured to: transmit, via the transceiver, a first RAN paging for MT-SDT; receive, via the transceiver, downlink non-SDT data for a UE after transmitting the first RAN paging; and transmit, via the transceiver, information of non-SDT data arrival for transmitting the downlink non-SDT data.

According to some other embodiments of the present application, when the apparatus 900 is a RAN node, e.g., a receiving gNB of a UE the processor may be configured to: receive, via the transceiver, a first RAN paging for MT-SDT from a last serving BS of a UE; receive, via the transceiver, information of non-SDT data arrival from the last serving BS; and transmit, via the transceiver, a message overwriting the first RAN paging to the UE in response to the information of non-SDT data arrival in the case that the first RAN paging has not been transmitted yet.

According to some yet other embodiments of the present application, when the apparatus 900 is a UE, the processor may be configured to: receive, via the transceiver, a first RAN paging for MT-SDT data; receive, via the transceiver, a second RAN paging overwriting the first RAN paging; and initialize a RRC resume procedure in response to the second RAN paging in the case that a MT-SDT procedure in response to the first RAN paging has not be initialized.

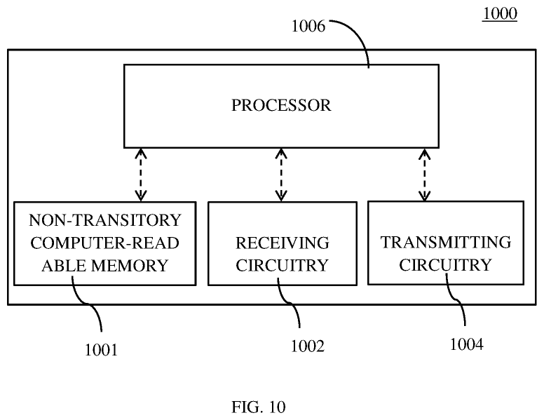

For example, FIG. 10 illustrates a block diagram of an apparatus 800 of data transmission according to some other embodiments of the present application.

As shown in FIG. 10, the apparatus 1000 may include at least one non-transitory computer-readable medium 1001, at least one receiving circuitry 1002, at least one transmitting circuitry 1004, and at least one processor 1006 coupled to the non-transitory computer-readable medium 1001, the receiving circuitry 1002 and the transmitting circuitry 1004. The apparatus 1000 may be a RAN node or a terminal device (e.g., a UE) configured to perform a method illustrated in the above or the like.

Although in this figure, elements such as the at least one processor 1006, transmitting circuitry 1004, and receiving circuitry 1002 are described in the singular, the plural is contemplated unless a limitation to the singular is explicitly stated. In some embodiments of the present application, the receiving circuitry 1002 and the transmitting circuitry 1004 can be combined into a single device, such as a transceiver. The processor 1006 may be a CPU, a DSP, a microprocessor etc. In certain embodiments of the present application, the apparatus 1000 may further include an input device, a memory, and/or other components.

In some embodiments of the present application, the non-transitory computer-readable medium 1001 may have stored thereon computer-executable instructions to cause the processor 1006 to implement the method with respect to the RAN node, e.g., a gNB or last gNB as described above. For example, the computer-executable instructions, when executed, cause the processor 1006 interacting with receiving circuitry 1002 and transmitting circuitry 1004, so as to perform the steps with respect to a gNB or a last serving gNB of a UE as depicted above.

In some embodiments of the present application, the non-transitory computer-readable medium 1001 may have stored thereon computer-executable instructions to cause a processor to implement the method with respect to the terminal device as described above. For example, the computer-executable instructions, when executed, cause the processor 1006 interacting with receiving circuitry 1002 and transmitting circuitry 1004, so as to perform the steps with respect to a receiving gNB of a UE as depicted above.

In some embodiments of the present application, the non-transitory computer-readable medium 1001 may have stored thereon computer-executable instructions to cause a processor to implement the method with respect to the UE as described above. For example, the computer-executable instructions, when executed, cause the processor 1006 interacting with receiving circuitry 1002 and transmitting circuitry 1004, so as to perform the steps with respect to the UE as depicted above.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

Please make the following amendments to the claims:

1. A radio access network (RAN) node, comprising:
at least one memory; and
at least one processor coupled with the at least one memory and configured to cause the RAN node to:
transmit a first RAN paging for mobile terminated (MT)-small data transmission (SDT);
receive downlink non-SDT data for a user equipment (UE) after transmitting the first RAN paging; and
transmit information of non-SDT data arrival for transmitting the downlink non-SDT data.

2. The RAN node of claim 1, wherein the information of non-SDT data arrival is transmitted in response to arrival of the downlink non-SDT data within running time of a timer.

3. The RAN node of claim 2, wherein the information of non-SDT data arrival is a second RAN paging for non-SDT transmitted to the UE to overwrite the first RAN paging.

4. The RAN node of claim 2, wherein the information of non-SDT data arrival is a second RAN paging for non-SDT transmitted to a receiving base station (BS) of the UE to overwrite the first RAN paging.

5. The RAN node of claim 2, wherein the information of non-SDT data arrival is an indication of overwriting the first RAN paging in a second RAN paging for non-SDT transmitted to a receiving base station (BS) of the UE.

6. The RAN node of claim 1, wherein the information of non-SDT data arrival is transmitted in the case of receiving a request message in response to the first RAN paging within running time of a timer.

7. The RAN node of claim 1, further comprising: a central unit (CU) control plane (CP) and a CU user plane (UP) coupled to the CU CP, wherein, the CU UP transmits information indicating whether downlink data arrival is SDT data arrival or non-SDT data arrival to the CU CP in response to the downlink data arrival, and the CU CP transmits the first RAN paging in response to the information indicating SDT data arrival.

8. The RAN node of claim 1, wherein the MT-SDT is for signaling radio bearer (SRB), and the at least one processor is configured to cause the RAN node to:
receive an indication indicating whether a signaling for the UE released into the RRC non-connected state is subject to SDT; and
transmit the first RAN paging in the case that the signaling is indicated as being subject to SDT.

9. A radio access network (RAN) node, comprising:
at least one memory; and
at least one processor coupled with the at least one memory and configured to cause the RAN node to:
receive a first RAN paging for mobile terminated (MT)-small data transmission (SDT) from a last serving base station of a user equipment (UE);
receive information of non-SDT data arrival from the last serving base station; and
transmit a message overwriting the first RAN paging to the UE in response to the information of non-SDT data arrival in the case that the first RAN paging has not been transmitted yet.

10. The RAN node of claim 9, wherein the information of non-SDT data arrival is a second RAN paging for non-SDT to overwrite the first RAN paging, and the message is the second RAN paging.

11. The RAN node of claim 9, wherein the information of non-SDT data arrival is an indication of overwriting the first RAN paging in a second RAN paging for non-SDT to overwrite the first RAN paging, and the message is the second RAN paging.

12. The RAN node of claim 9, wherein the at least one processor is configured to cause the RAN node to transmit a retrieval UE context request, the information of non-SDT data arrival is an indication of non-SDT data arrival in a retrieval UE context response message in response to the retrieval UE context request, and the message is a radio resource control (RRC) resume message.

13. The RAN node of claim 9, wherein, in the case that the first RAN paging has been transmitted to the UE before receiving the information of non-SDT data arrival, the at least one processor is configured to cause the RAN node to ignore the information of non-SDT data arrival or transmit a feedback to the last serving BS indicating the first RAN paging has been transmitted to the UE.

14. A remote apparatus, comprising:
at least one memory; and
at least one processor coupled with the at least one memory and configured to cause the remote apparatus to:
receive a first radio access network (RAN) paging for mobile terminated (MT)-small data transmission (SDT);
receive a second RAN paging overwriting the first RAN paging; and
initialize a radio resource control (RRC) resume procedure in response to the second RAN paging in the case that a MT-SDT procedure in response to the first RAN paging not being initialized.

15. The remote apparatus of claim 14, wherein the at least one processor is configured to cause the remote apparatus to initialize the MT-SDT procedure by a RRC layer in response to the first RAN paging before receiving the second RAN paging.

16. A radio access network (RAN) node, comprising:
at least one memory; and
at least one processor coupled with the at least one memory and configured to cause the RAN node to:
determine reception of small data transmission (SDT) downlink data; and
transmit information indicating the reception of the SDT downlink data.

17. The RAN node of claim 16, wherein the at least one processor is configured to cause the RAN node to transmit a paging message to a user equipment (UE).

18. The RAN node of claim 16, wherein the at least one processor is configured to cause the RAN node to transmit an SDT data threshold to a user plane (UP).

19. The RAN node of claim 16, further comprising: a central unit (CU) control plane (CP) and a CU user plane (UP) coupled to the CU CP.

20. The RAN node of claim 19, wherein the CU UP transmits information indicating whether downlink data arrival is SDT data arrival or non-SDT data arrival to the CU CP in response to the downlink data arrival.
